(19) United States
(12) Patent Application Publication
(10) Pub. No.: US 2022/0006684 A1
(43) Pub. Date: Jan. 6, 2022

(54) COAP-BASED OPC UA MESSAGE TRANSMISSION METHOD, AND SERVER

(71) Applicant: CHONGQING UNIVERSITY OF POSTS AND TELECOMMUNICATIONS, Chongqing (CN)

(72) Inventors: Chenggen PU, Chongqing (CN); Yi WANG, Chongqing (CN); Ping WANG, Chongqing (CN); Junrui WU, Chongqing (CN)

(73) Assignee: CHONGQING UNIVERSITY OF POSTS AND TELECOMMUNICATIONS, Chongqing (CN)

(21) Appl. No.: 17/296,993

(22) PCT Filed: Nov. 7, 2019
(86) PCT No.: PCT/CN2019/116134

§ 371 Date: May 26, 2021

(30) Foreign Application Priority Data
Dec. 4, 2018 (CN) 201811476189.6

(51) Int. Cl. H04L 12/24

(52) U.S. Cl. CPC H04L 41/0226; H04L 41/0246

(57) ABSTRACT

The present application relates to a CoAP-based OPC UA message transmission method, comprising: packaging and encoding data by using an OPC UA information model; packaging an entire OPC UA data message into a load part of a CoAP message; then, on the basis of a UA-CoAP server, querying whether a CoAP-to-HTTP proxy server is present in a network; if present, transmitting a UA-CoAP data message to the CoAP-to-HTTP proxy server; converting the received data message into HTTP; and transmitting the data message to an OPC UA client. The present application solves the problem wherein data of a limited-resource industrial field device cannot be uniformly described and cannot be uniformly accessed, while the requirement of the industrial field device accessing a web service is satisfied.

### CROSS REFERENCE OF RELATED APPLICATION

This application claims priority to Chinese Patent Application No. 201811476189.6, titled “COAP-BASED OPC UA MESSAGE TRANSMISSION METHOD FOR RESOURCE-CONSTRAINED INDUSTRIAL FIELD DEVICE”, filed on Dec. 4, 2018 with the China National Intellectual Property Administration (CNIPA), which is incorporated herein by reference in its entirety.

### FIELD

The present disclosure relates to the technical field of industrial communication, and particularly, to a method for transmitting an OPC UA message based on CoAP.

### BACKGROUND

Constrained Application Protocol (CoAP) is a Web transmission protocol specifically for a resource-constrained node and network in Internet of Things proposed by Internet Engineering Task Force (IETF) in 2014. Its appearance provides a solution with low power consumption, high security, and scalability for a network containing the resource-constrained node.

OPC Unified Architecture (OPC UA) is a key technology released by OPC Foundation in 2006 to solve the problem of data interconnection in a multi-protocol network. In addition to seamless data transmission, OPC UA also has characteristics of building an information model, and secure and platform-independent communication. OPC UA provides a common technology and semantic operation layer for machine-to-machine (M2M) communication, which plays a vital role in realizing interconnection of industrial Internet.

At present, data of a resource-constrained industrial field device cannot be uniformly described and cannot be uniformly accessed.

### SUMMARY

A method for transmitting an OPC UA message based on CoAP is provided in the present disclosure, which can meet a need of a resource-constrained industrial field device to access a Web service, to realize seamless connection of an industrial field network from top (such as cloud, enterprise resource planning (ERP), and manufacturing execution system (MES)) to down (such as a gateway, and an underlying field device).

To achieve the above objectives, the present disclosure provides the following technical solutions.

In a first aspect, a method for transmitting an OPC UA message based on CoAP is provided in the present disclosure, which including: an OPC UA server using CoAP (hereinafter “UA-CoAP server”) obtains data from an data acquisition terminal of a resource-constrained industrial field device, encapsulates the data using an OPC unified architecture (OPC UA) information model, encodes the encapsulated data in binary format or extensive markup language (XML) format, and encapsulates the entire OPC UA data message into a payload of a CoAP message, i.e., an UA-CoAP data message, then the UA-CoAP server queries whether there is a proxy server (hereinafter “CoAP-to-HTTP proxy server”, which is usually installed on a boundary gateway or boundary router) that converts hypertext transfer protocol (HTTP) into the CoAP in a network. If the CoAP-to-HTTP proxy server exists, the UA-CoAP server sends the UA-CoAP data message to the CoAP-to-HTTP proxy server located at a network boundary (which is usually the boundary gateway or boundary router) of an underlying industrial field device; if there is no CoAP-to-HTTP proxy server, the UA-CoAP server discards the UA-CoAP data message, and perform direct transmission in a manner of transmission control protocol (TCP).

Optionally, in combination with the above first aspect, in a first possible implementation manner, the process that the UA-CoAP server encapsulates the collected original data using the OPC UA information model, encodes the encapsulated data in a binary format or XML format, and encapsulates the OPC UA data message into the payload of the CoAP message includes: the UA-CoAP server reconstructs a header in constructing the UA-CoAP data message, the main content contained in the header is a type of message function, an unique message identifier (ID) for repeated check and error check, an encoding type of OPC UA information, an option of additional CoAP function, and length of data message.

Optionally, in combination with the above first aspect, in a second possible implementation manner, the process that the UA-CoAP server queries whether there is the CoAP-to-HTTP proxy server in the network includes: sending a request frame to query whether the border gateway or border router has a function of proxy conversion, and determining that the CoAP-to-HTTP proxy server exists if a corresponding acknowledgement frame is received; and determining that the CoAP-to-HTTP proxy server does not exist if no acknowledgement frame is received within a limited period of time.

Optionally, in combination with the second possible implementation manner of the above first aspect, in a third possible implementation manner, the method further includes: when the UA-CoAP server sends the query request frame to the border gateway or border router, the proxy server replies the acknowledgement frame to the UA-CoAP server if the CoAP-to-HTTP proxy server exists, and the UA-CoAP server discards the constructed UA-CoAP data message and transmits the data message in a manner of OPC UA-TCP if no acknowledgement frame is received after sending query request frame multiple times within the limited period of time.

In a second aspect, a method for transmitting an OPC UA message based on CoAP is provided in the present disclosure, which including: after receiving a data message, the CoAP-to-HTTP proxy server converts CoAP into HTTP with OPC UA information being unchanged; after conversion, the CoAP-to-HTTP proxy server forms an HTTP data message containing the original OPC UA information. Since OPC UA supports a data message in HTTP format, the CoAP-to-HTTP proxy server directly sends the data message to a standard OPC UA client in an external network for subsequent data analysis.

Optionally, in combination with the above second aspect, in a first possible implementation manner, the method further includes: the CoAP-to-HTTP proxy server replies to the UA-CoAP server with an acknowledgement frame, so that if the UA-CoAP server fails to get a reply of the acknowledgement frame after sending the query request frame multiple times within a limited period of time, the UA-CoAP server discards the constructed UA-CoAP data message and transmit the data messages in a manner of OPC UA-TCP

Optionally, in combination with the above second aspect, in a second possible implementation manner, the CoAP-to-HTTP proxy server runs on a border gateway or a border router, and supports a function of converting between standard CoAP data and a standard HTTP data message.

In a third aspect, a first server is provided in the present disclosure, which has a function of implementing the method of the foregoing first aspect or any one of the possible implementation manners of the first aspect. This function can be realized by hardware, or by hardware executing corresponding software. The hardware or software includes one or more modules corresponding to the above-mentioned function.

In a fourth aspect, a second server is provided in the present disclosure, which has a function of implementing the method of the foregoing second aspect or any one of the possible implementation manners of the second aspect. This function can be realized by hardware, or by hardware executing corresponding software. The hardware or software includes one or more modules corresponding to the above-mentioned function.

In a fifth aspect, a storage medium is provided in the present disclosure, instructions are stored on the storage medium. The instructions, when being executed on an electronic device, cause the electronic device to execute the method for transmitting the OPC UA message based on CoAP in the foregoing first aspect or any one of the possible implementation manners of the first aspect.

In a sixth aspect, a storage medium is provided in the present disclosure, instructions are stored on the storage medium. The instructions, when being executed on an electronic device, cause the electronic device to execute the method for transmitting the OPC UA message based on CoAP in the foregoing second aspect or any one of the possible implementation manners of the second aspect.

In a seventh aspect, a program product including instructions is provided in the present disclosure. The program product, when running on an electronic device, enables the electronic device to execute the method for transmitting the OPC UA message based on CoAP in the foregoing first aspect or any one of the possible implementation manners of the first aspect.

In an eighth aspect, a program product including instructions is provided in the present disclosure. The program product, when running on an electronic device, enables the electronic device to execute the method for transmitting the OPC UA data message based on CoAP in the foregoing second aspect or any one of the possible implementation manners of the second aspect.

In view of the problem that data of the resource-constrained industrial field device cannot be uniformly described and cannot be uniformly accessed, and to meet the need of the resource-constrained industrial field device to access the Web service, the present disclosure designs the method for transmitting the OPC UA message based on CoAP which is suitable for the underlying device. REST architecture of the CoAP can realize a function that the underlying device to access the Web service, while the OPC UA can perform uniform modeling on data in multiple protocol formats at an underlying layer. The combination of the REST architecture of the CoAP and the OPC UA can ensure interconnection and lightweight communication of the data of the underlying device to a certain extent.

### BRIEF DESCRIPTION OF THE DRAWINGS

FIG. 1 is a schematic view of a communication protocol stack adopted in the present disclosure;

FIG. 2 is a structural chart of an UA-CoAP server provided in the present disclosure;

FIG. 3 is a schematic view of a header of a UA-CoAP data message provided in the present disclosure;

FIG. 4 is a connection diagram of communication when there is a proxy conversion service provided in the present disclosure;

FIG. 5 is a flow chart of a method for transmitting an OPC UA message based on CoAP provided in the present disclosure;

FIG. 6 is a structural chart of a communication device provided in the present disclosure; and

FIG. 7 is a structural chart of a communication device provided in the present disclosure.

### DETAILED DESCRIPTION

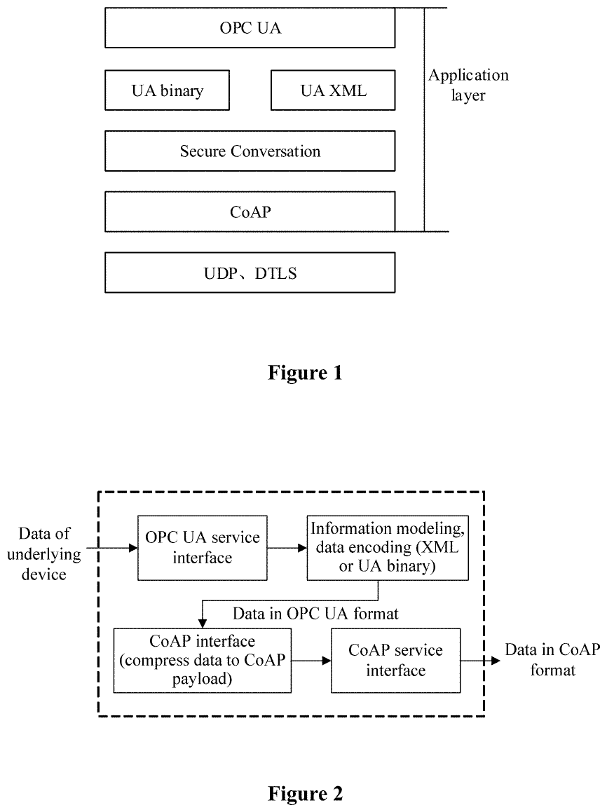

FIG. 1 is a communication protocol stack designed by a preferred embodiment of the present disclosure. The communication protocol stack mainly includes: OPC UA, a secure channel, and an application layer protocol family constituted by CoAP. OPC UA may adopt UA binary or XML encoding format for encoding according to application scenarios.

FIG. 2 is a UA-CoAP server designed by a preferred embodiment of the present disclosure. A main function of the UA-CoAP server is: receiving underlying data and constructing an OPC UA information model, encoding the constructed data and encapsulating the encoded data into a payload of a standard CoAP data message, and sending a query request frame to query whether there is a proxy conversion server.

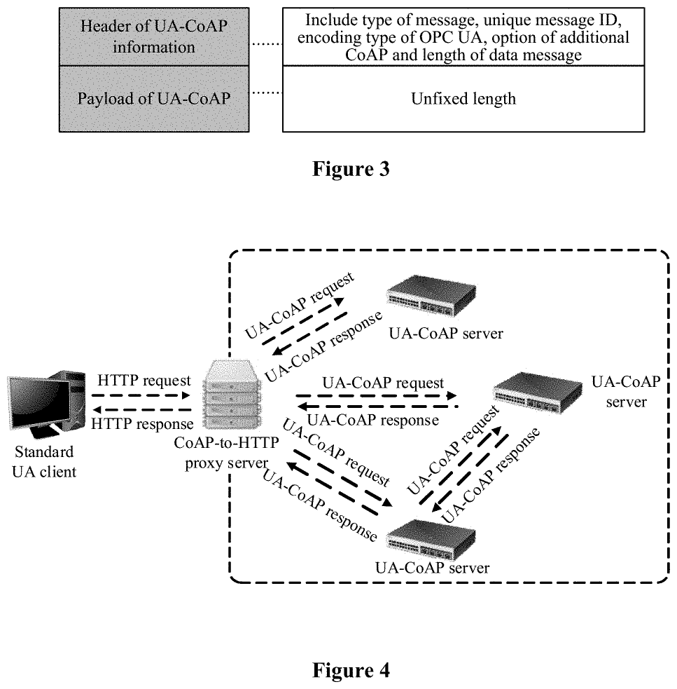

FIG. 3 is a header of a UA-CoAP data message designed by a preferred embodiment of the present disclosure. Main content of the header of the UA-CoAP data message includes: IP protocol version, a type of message function, the unique message ID for repeated check and error check, an encoding type of OPC UA information, option of additional CoAP function and length of the data message.

FIG. 4 is a communication mode when there is a proxy conversion service designed by a preferred embodiment of the present disclosure. Main content of the communication mode includes that: the redesigned UA-CoAP server transmits data to a CoAP-to-HTTP proxy server at a network boundary, a converted HTTP data message can be communicated with a standard OPC UA client directly. An advantage of this communication mode is to better support a Web service, and the original UA client does not need to be changed.

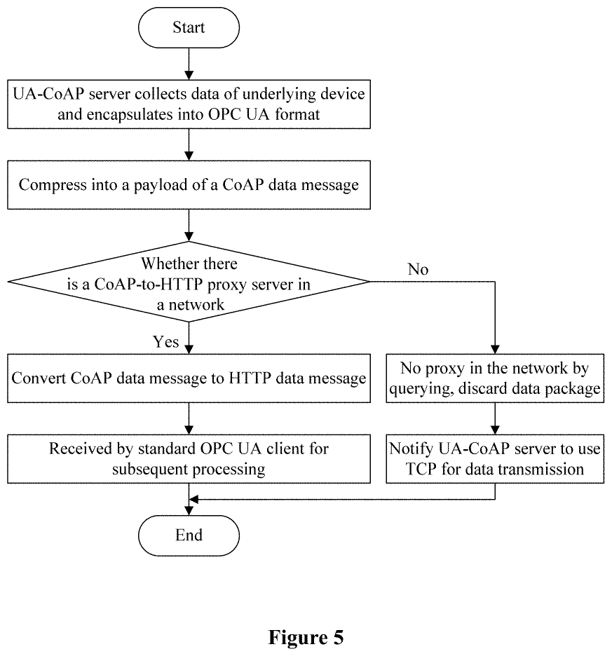

FIG. 5 is a process of a method for transmitting an OPC UA message based on CoAP in a preferred embodiment of the present disclosure. The transmission method is mainly carried out on the server, the client and the proxy conversion server. As illustrated in FIG. 5, a specific implementation process is described in Steps 1-5 below.

In Step 1, the UA-CoAP server collects data of an underlying device, encodes the collected data in a binary format or XML format, and encapsulates the data in OPC UA format.

In Step 2, in the UA-CoAP server, the data in OPC UA format is encapsulated into the payload of the CoAP data message. Meanwhile, the header of the UA-CoAP data message is reconstructed, encoding format information of the OPC UA data in the payload is added, and a unique number is given to ensure a correct data transmission sequence.

In Step 3, the UA-CoAP server queries whether there is a CoAP-to-HTTP proxy conversion server in a network, proceeds to a next step if the CoAP-to-HTTP proxy conversion server exists, and discards the UA-CoAP data packet and transmit the OPC UA information in a manner of TCP if the CoAP-to-HTTP proxy conversion server does not exist.

In Step 4, if the HTTP-CoAP proxy conversion server exists in the network, the UA-CoAP server sends the UA-CoAP data message to the proxy server for format conversion, to convert the UA-CoAP data message into the standard HTTP data message.

In Step 5, since OPC UA protocol itself supports a transmission mode of HTTP, a standard OPC UA client can be used to receive the converted UA-CoAP data message. After that, the client extracts data modeling information and a data value in the message for further data processing.

It is understandable that, in order to realize the aforementioned functions, the aforementioned UA-CoAP server and CoAP-to-HTTP proxy conversion server include hardware structures and/or software modules corresponding to each function. In the following, a first server is used to represent the UA-CoAP server, and a second server is used to represent the CoAP-to-HTTP proxy conversion server. Those skilled in the art should easily realize that in combination with modules and algorithm steps of the examples described in the embodiments disclosed herein, the present disclosure can be implemented in a form of hardware or a combination of hardware and software. Whether a certain function is executed by hardware or software-driven hardware depends on a specific application and design constraint conditions of the technical solutions. Professionals can use different methods for each specific application to implement the described functions, but such implementation should not be considered beyond the scope of the present disclosure.

Described in terms of hardware structure, the first server may be implemented by one physical device, or may be implemented by multiple physical devices together, or may be a logical function module in one physical device, and the second server may be implemented by one physical device, or may be implemented by multiple physical devices, or may be a logical function module in one physical device, which are not specifically limited in the embodiments of the present disclosure.

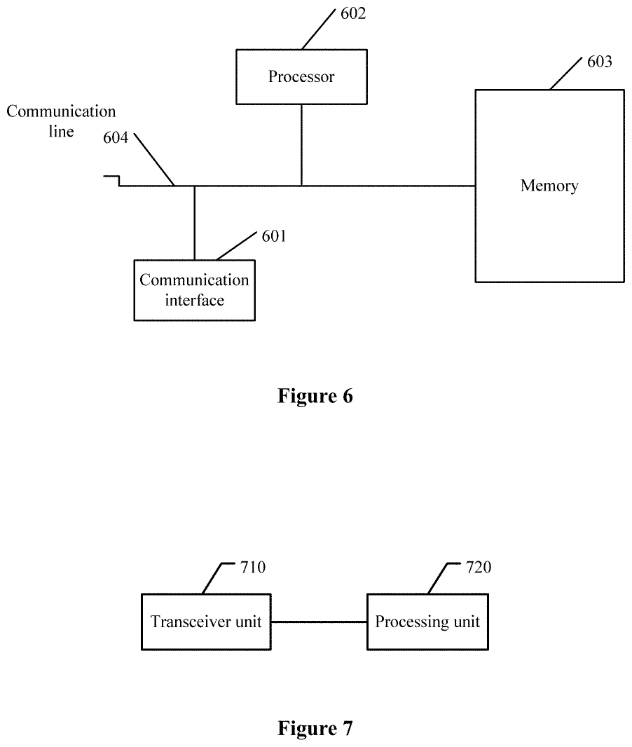

For example, the first server or the second server may be implemented by a communication device in FIG. 6. FIG. 6 illustrates a schematic diagram of a hardware structure of a communication device provided by an embodiment of the present disclosure. The communication device includes: a communication interface 601 and a processor 602, and may also include a memory 603.

The communication interface 601 may be any device such as a transceiver, and is configured to communicate with other device or communication network, such as Ethernet, radio access network (RAN), and wireless local area networks (WLAN).

The processor 602 includes but is not limited to one or more of a central processing unit (CPU), a network processor (NP), an application-specific integrated circuit (ASIC) and a programmable logic device (PLD). The above-mentioned PLD may be a complex programmable logic device (CPLD), a field-programmable gate array (FPGA), a generic array logic (GAL) or any combination thereof. The processor 602 is responsible for a communication line 604 and general processing, and may also provide various functions, including timing, peripheral interfaces, voltage regulation, power management, and other control functions. The memory 603 may be used to store data used by the processor 602 when performing operations.

The memory 603 may be a read-only memory (ROM) or other type of static storage devices that can store static information and instructions, random access memory (RAM), or other type of dynamic storage devices that can store information and instructions, or may also be electrically erasable programmable read-only memory (EEPROM), compact disc read-only memory (CD-ROM) or other optical disk storage, CD storage (including compressed CD, laser disk, CD, digital versatile CD, and Blu-ray CD), magnetic disk storage medium or other magnetic storage device, or any other medium that can be used to carry or store desired program codes in a form of instructions or data structures and can be accessed by a device, but are not limited to these. The memory may exist independently and connected to the processor 602 through the communication line 604. The memory 603 may also be integrated with the processor 602. If the memory 603 and the processor 602 are independent devices, the memory 603 and the processor 602 are connected, for example, the memory 603 and the processor 602 can communicate through the communication line. The communication interface 601 and the processor 602 may communicate through the communication line, and the communication interface 601 may also be directly connected to the processor 602.

The communication line 604 may include any number of interconnected buses and bridges, and the communication line 604 links various circuits including one or more processors 602 represented by the processor 602 and a memory represented by the memory 603 together. The communication line 604 may also link various other circuits such as a peripheral device, a voltage regulator, and a power management circuit together, which are all known in the art, and therefore, no further description thereof is provided in this application.

When the communication device is the first server, in a specific implementation, the first server may include: a memory, a processor, and a communication interface.

The memory is configured to store readable instructions.

The processor is coupled with the memory, and is configured to execute the readable instructions in the memory to perform following operations:

encapsulating collected original data using an OPC UA information model, encoding the encapsulated data in a binary format or extensive markup language (XML) format, and encapsulating an OPC UA data message into a payload of a constrained application protocol (CoAP) message, the first server being an OPC UA server based on CoAP; and

querying whether there is a second server in a network, the second server being a proxy server that converts the CoAP into hypertext transfer protocol (HTTP).

The communication interface is coupled to the processor, and is configured to, if the second proxy server exists, send a UA-CoAP data message to the second proxy server located at a network boundary of an underlying industrial field device, to cause the second proxy server, after receiving the data message, to convert the CoAP into the HTTP with OPC UA information being unchanged, and to form after the conversion an HTTP data message containing the original OPC UA information, and directly send the data message to a standard OPC UA client in an external network for subsequent data analysis; and if there is no second proxy server, the process discards the UA-CoAP data message, and performs direct transmission using transmission control protocol (TCP).

In a specific embodiment, the processor is specifically configured to: reconstruct a header in constructing the data message, the header comprising a type of message function, an encoding type of OPC UA information, an option of additional CoAP function, and length of the data message.

In a specific embodiment, the communication interface is specifically configured to send a request frame to query whether a border gateway or border router has a function of proxy conversion, and the processor is configured to determine that the second server exists if a corresponding acknowledgement frame is received, and determine that the second server does not exist if no acknowledgement frame is received by the communication interface within a limited period of time.

In a specific embodiment, the processor is specifically configured to, if no acknowledgement frame is received by the communication interface within the limited period of time, discard the constructed UA-CoAP data message, and transmit the date message in a manner of OPC UA-TCP.

When the communication device is the second server, in a specific implementation, the second server may include: a communication interface, a memory, and a processor.

The communication interface is configured to send and receive data messages.

The memory is configured to store readable instructions.

The processor is coupled with the memory, and is configured to execute the readable instructions in the memory to perform following operations:

converting, after the communication interface receives the data message, constrained application protocol (CoAP) into hypertext transfer protocol (HTTP) with OPC UA information being unchanged, the data message being obtained by encapsulating by a first server collected original data using an OPC UA information model, encoding the encapsulated data in a binary format or XML, format and encapsulating an OPC UA data message into a payload of a CoAP message, the second server being a proxy server that converts the CoAP into HTTP, and the first server being an OPC UA server based on CoAP; and

forming, after conversion is performed by the processor, an HTTP data message containing the original OPC UA information, and the communication interface is further configured to directly send the data message to a standard OPC UA client in an external network for subsequent data analysis.

In a specific implementation, the communication interface is further configured to, if receiving a query request frame sent by the first server, reply an acknowledgement frame to the first server, so that the first server discards the constructed UA-CoAP data message and transmits the data message in a manner of OPC UA-TCP if the first server fails to get a reply of the acknowledgement frame after sending the query request frame within a limited period of time.

In a specific implementation, the second proxy server runs on a border gateway or a border router, and supports a function of converting between standard CoAP data and a standard HTTP data message.

In the embodiments of the present disclosure, the communication interface may be regarded as a transceiver unit of a node, the processor with processing function may be regarded as a processing unit of the node, and the memory may be regarded as a storage unit of the node. As illustrated in FIG. 7, the foregoing first server may include a transceiver unit 710 and a processing unit 720, and the second server may also include a transceiver unit 710 and a processing unit 720. The transceiver unit may also be referred to as a transceiver, a transceiver set, or a transceiver device. The processing unit may also be called a processor, a processing board, a processing module, or a processing device. Optionally, a device for implementing a receiving function in the transceiver unit 710 may be regarded as a receiving unit, and a device for implementing a sending function in the transceiver unit 710 may be regarded as a sending unit, that is, the transceiver unit 710 includes a receiving unit and a sending unit. The transceiver unit may sometimes be called a transceiver set, a transceiver, or a transceiver circuit. The receiving unit may sometimes be called a receiving set, a receiver, or a receiving circuit. The sending unit may sometimes be called a transmitting set, a transmitter, or a transmitting circuit.

The foregoing embodiments may be implemented in whole or in part by software, hardware, firmware, or any combination thereof. When implemented by software, they can be implemented in the form of a program product in whole or in part.

The program product includes one or more instructions. When the program instructions are loaded and executed on an electronic device, processes or functions described in the embodiments of the present disclosure are generated in whole or in part. The electronic device may be a general-purpose computer, a special-purpose computer, a sensor node, or other device that can recognize program instructions. The instructions may be stored in a readable storage medium, or transmitted from one readable storage medium to another readable storage medium. For example, the instructions may be transmitted from a website, computer, sensor, server, or data center through a wired mode (for example, coaxial cable, optical fiber, or digital subscriber line (DSL)) or a wireless mode (such as infrared, wireless, or microwave) to another website site, computer, sensor, server or data center. The readable storage medium may be any available medium that can be stored by the electronic device or a data storage device such as a server or data center integrated with one or more available media. The available medium may be a magnetic medium (for example, a floppy disk, a hard disk, and a magnetic tape), an optical medium (for example, a DVD), or a semiconductor medium (for example, a solid state disk (SSD)).

Those of ordinary skill in the art can understand that all or part of the steps in the various methods of the above-mentioned embodiments can be completed by instructing relevant hardware through a program. The program can be stored in a storage medium. The storage medium may include: ROM, RAM, Disk or CD.

1. A method for transmitting an OPC UA message based on CoAP, comprising:
encapsulating, by a first server, collected original data using an OPC UA information model, encoding the encapsulated data in a binary format or extensive markup language (XML) format to obtain an OPC UA data message, and encapsulating the OPC UA data message into a payload of a constrained application protocol (CoAP) message to obtain an UA-CoAP data message, the first server being an OPC UA server based on CoAP;
querying, by the first server, whether there is a second server in a network, the second server being a proxy server that converts the CoAP into hypertext transfer protocol (HTTP); and
if the second proxy server exists, sending, by the first server, the UA-CoAP data message to the second proxy server located at a network boundary of an underlying industrial field device, to cause the second proxy server, after receiving the data message, to convert the CoAP into the HTTP with OPC UA information being unchanged, and to form after the conversion a HTTP data message containing the original OPC UA information, and directly send the data message to a standard OPC UA client in an external network for subsequent data analysis; and
if there is no second proxy server, discarding, by the first server, the UA-CoAP data message, and performing direct transmission using transmission control protocol (TCP).

2. The method according to claim 1, wherein, encapsulating, by the first server, the collected original data using the OPC UA information model, encoding the encapsulated data in a binary format or an extensive markup language (XML) format, and encapsulating the OPC UA data message into the payload of the constrained application protocol (CoAP) message comprises:
reconstructing, by the first server, a header in constructing the data message, the header comprising a type of message function, an encoding type of OPC UA information, an option of additional CoAP function, and length of data message.

3. The method according to claim 1, wherein, querying, by the first server, whether there is a second server in the network, the second server being a proxy server that converts the CoAP into HTTP comprises:
sending a request frame to query whether a border gateway or a border router has a function of proxy conversion, and determining that the second server exists if a corresponding acknowledgement frame is received; and
determining that the second server does not exist if no acknowledgement frame is received within a limited period of time.

4. The method according to claim 3, wherein, if no acknowledgement frame is received within the limited period of time, the method further comprises:
discarding, by the first server, the constructed UA-CoAP data message, and transmitting the date message in a manner of UA-TCP.

5. A method for transmitting an OPC UA message based on CoAP, comprising:
converting, by the second proxy server after receiving a data message, constrained application protocol (CoAP) into hypertext transfer protocol (HTTP) with OPC UA information being unchanged, the data message being obtained by encapsulating by a first server collected original data using an OPC UA information model, encoding the encapsulated data in a binary form or extensive markup language (XML) format to obtain an OPC UA data message and encapsulating the OPC UA data message into a payload of a CoAP message, the second server being a proxy server that converts the CoAP into the HTTP, and the first server being an OPC UA server based on CoAP; and
forming, by the second proxy server after the conversion, an HTTP data message containing the original OPC UA information, and directly sending the data message to a standard OPC UA client in an external network for subsequent data analysis.

6. The method according to claim 5, wherein, the method further comprises:
if the second server receives a query request frame sent by the first server, replying, by the second server, an acknowledgement frame to the first server, so that the first server discards the constructed UA-CoAP data message and transmits the data message in a manner of UA-TCP if the first server fails to get a reply of the acknowledgement frame after sending the query request frame multiple times within a limited period of time.

7. The method according to claim 5, wherein,
the second proxy server runs on a border gateway or a border router, and supports a function of converting between a standard CoAP data message and a standard HTTP data message.

8-25. (canceled)
